(19) United States
(12) Patent Application Publication
(10) Pub. No.: US 2019/0259150 A1
(43) Pub. Date: Aug. 22, 2019

(54) AUTONOMOUS MARKING SYSTEM

(71) Applicant: Walmart Apollo, LLC, Bentonville, AR (US)

(72) Inventors: Donald High, Noel, MO (US); Robert Cantrell, Herndon, VA (US); Brian Gerard McHale, Oldham (GB); Matthew David Alexander, Rogers, AR (US); Jeremy Velten, Bella Vista, AR (US); William Mark Propes, Bentonville, AR (US)

(21) Appl. No.: 16/280,694

(22) Filed: Feb. 20, 2019

Related U.S. Application Data
(60) Provisional application No. 62/802,543, filed on Feb. 7, 2019.
(60) Provisional application No. 62/632,548, filed on Feb. 20, 2018.

(51) Int. Cl. G06T 7/00; G05D 1/00; B64C 39/02; G06F 16/903

(52) U.S. Cl. CPC G06T 7/0004; G05D 1/0088; G05D 1/0027; G06T 2207/30204; G06F 16/903; B64C 2201/12; B64C 39/024

(57) ABSTRACT

Described in detail herein is an automated marking system. The autonomous robot device can locate and identify one or more cases stored in at least one of a plurality of bins in the first location of the facility, wherein each case containing a set of like physical objects. The autonomous robot device can transmit identifying information of the at least one of the one or more cases to the computing system. The computing system can determine a priority for a quantity of the first set of like physical objects to be moved from the at least one of the one or more cases to the second location of the facility. The computing system can instruct the at least one autonomous robot device to mark the at least one of the one or more cases with an identifying mark denoting the determined priority.

### CROSS-REFERENCE TO RELATED PATENT APPLICATIONS

This application claims priority to U.S. Provisional Application No. 62/632,548 filed on Feb. 20, 2018 and U.S. Provisional Application No. 62/802,543 filed on Feb. 7, 2019, the contents of each application are hereby incorporated by reference in their entirety.

### BACKGROUND

Autonomous robot systems can perform various tasks without human intervention.

Identifying when such tasks are completed and the outcome of such tasks can be a slow and error prone process, particularly when the tasks relate to physical objects being removed and replaced.

### BRIEF DESCRIPTION OF DRAWINGS

Illustrative embodiments are shown by way of example in the accompanying drawings and should not be considered as a limitation of the present disclosure:

FIG. 1 is a block diagram illustrating physical objects disposed on a shelving unit in a facility according to an exemplary embodiment of the present disclosure;

FIG. 2 is a block diagram illustrating a portable electronic device according to an exemplary embodiment of the present disclosure;

FIG. 3 is a block diagram illustrating an autonomous robot device operating in a facility according to exemplary embodiments of the present disclosure;

FIG. 4 is a block diagram of marked bins and/or cases in accordance with an exemplary embodiment;

FIG. 5 is a schematic diagram of a portable electronic device depicting a virtual element superimposed on bins and/or cases according to an exemplary embodiment;

FIG. 6 is a block diagram of the dispensing device in accordance with an exemplary embodiment;

FIG. 7 is a block diagrams illustrating an automated robot marking system according to exemplary embodiments of the present disclosure;

FIG. 8 is a block diagrams illustrating of an exemplary computing device in accordance with exemplary embodiments of the present disclosure;

FIG. 9 is a flowchart illustrating an exemplary process in accordance with exemplary embodiments of the present disclosure;

FIG. 10 is a flowchart illustrating an exemplary process in accordance with exemplary embodiments of the present disclosure;

FIGS. 11A-11B depict a flowchart illustrating the process of the autonomous marking system according to exemplary embodiment; and

FIGS. 12A-12B depict a flowchart illustrating the process of the autonomous marking system according to exemplary embodiment.

### DETAILED DESCRIPTION

Described in detail herein is an automated marking system. An autonomous robot device can autonomously roam through a facility, and can be in selective communication with a computing system via a communications network. The autonomous robot device can include a controller, a drive motor, a dispensing/marking device, a reader and an image capturing device. The autonomous robot device can locate and identify one or more cases stored in at least one of a plurality of bins in a first location of the facility, wherein each case contains one or more physical objects (a set of like physical objects). For example, a case can contain several individually packaged items (a case of cereal boxes), can form the packing for an item (a case of dog food). The case can be formed of various materials based on its contents, and can include cardboard, plastic, paper, wood, and the like.) A bin, as used herein, can refer to a specified location or slot on a shelf or a specified apparatus for storing cases. The autonomous robot device can extract and decode identifying information associated with at least one of the one or more cases and/or bins, and can transmit the identifying information of the at least one of the one or more cases and/or bins to the computing system via the network.

The computing system can receive the identifying information associated with the physical object contained by the at least one of the one or more cases and/or at the associated bin, and can query a data storage facility to retrieve information associated with a quantity of the physical objects disposed in a second location of the facility. The computing system can determine that the quantity is below a specified quantity, and can determine a priority for a specified quantity of the physical objects to be moved from the at least one of the one or more cases (in the first location) to the second location of the facility. Based on the specified quantity and/or the priority, the computing system can instruct the at least one autonomous robot device to mark the bin and/or at least one of the one or more cases with an identifying mark denoting the determined priority.

The autonomous robot device can receive the instructions to mark the bin and/or case, can locate and identify the bin and/or case, and can mark the case with the identifying mark.

In some embodiments, the autonomous robot device can retrieve the identifying information associated with physical objects contained in a case, can retrieve the quantity information for the physical objects at the second location, and can determine the priority independent and without input from the computing system.

In one embodiment, an autonomous marking system can include a computing system in communication with a data storage facility and autonomous robot devices in selective communication with the computing system via a communications network. The autonomous robot devices include a controller, a drive motor, a dispensing device, a reader and an image capturing device. An autonomous robot device can be configured to autonomously roam in a first location of a facility, locate and identify one or more cases stored in at least one of a plurality of bins in the first location of the facility. Each case can contain a set of like physical objects. The autonomous robot device can be further configured to extract and decode identifying information associated with at least one of the one or more cases, and transmit the identifying information of the at least one of the one or more cases to the computing system.

The computing system can be programmed to receive the identifying information associated with the at least one of the one or more cases, query the data storage facility to retrieve information associated with a first set of like physical objects disposed within the at least one of the one or more cases, identify an identifying mark associated with a priority of the at least one of the one or more cases, generate a virtual element depicting the identifying mark, and associate at least one of the one or more cases with the virtual element depicting the identifying mark in the data storage facility.

The system can further include a portable electronic device including an image capturing device, a processing device, computer memory, and a display. The processing device of the portable electronic device can execute an application, and can be in communication with the computing system. The application when executed can be configured to control the operation of the image capturing device to contemporaneously and continuously image an area within a field of view of the image capturing device, render on the display the physical scene including the at least one of the one or more cases and the identifying information associated with the at least one of the one or more cases when the at least one of the one or more cases is in the area within the field of view of the image capturing device, parse the physical scene rendered on the display into the discrete elements based on dimensions of items in the physical scene, extract and decode the identifying information associated with at least one of the one or more cases, transmit the identifying information of the at least one of the one or more cases to the computing system, and in response to receiving instructions from the computing system, augment the physical scene rendered on the display to superimpose the virtual element depicting the identifying mark on the at least one of the one or more cases.

In one embodiment, an autonomous marking system can include a computing system in communication with a data storage facility and autonomous robot devices in selective communication with the computing system via a communications network. Each of the autonomous robot devices can include a controller, a drive motor, a dispensing device, a reader and an image capturing device. At least one of the autonomous robot devices can be configured to autonomously roam in a first location of a facility, and locate and identify one or more cases stored in at least one of a plurality of bins in the first location of the facility. Each case can contain a set of like physical objects. The autonomous robot device is further configured to extract and decode identifying information associated with at least one of the one or more cases, transmit the identifying information of the at least one of the one or more cases to the computing system.

The computing system can be programmed to receive the identifying information associated with the at least one of the one or more cases, query the data storage facility to retrieve information associated with a first set of like physical objects disposed within the case, identify an identifying mark for the at least one of the one or more cases based on the priority, instruct the at least one autonomous robot device to embed a sensing device in the at least one of the one or more cases.

The autonomous robot device can be configured to navigate to the at least one bin storing the at least one of the one or more cases, locate and identify the at least one of the one or more cases, embed the sensing device in the at least one of the one or more cases, and transmit an identifier encoded in the sensing device to the computing system.

The computing system can be configured to store and associate the identifier of the sensing device with the at least one of the one or more cases and the identified identifying mark. The system can further include a portable electronic device executing an application and including processing device, computer memory, a reader, and a display. The portable electronic device can be in communication with the computing system. In response to execution of the application, the portable electronic device can be configured to scan, using the reader, the sensing device embedded in the at least one of the one or more cases, decode the identifier from the sending device, transmit the identifier to the computing system, render the identifying mark associated with the at least one of the one or more cases on the display, in response to receiving instructions.

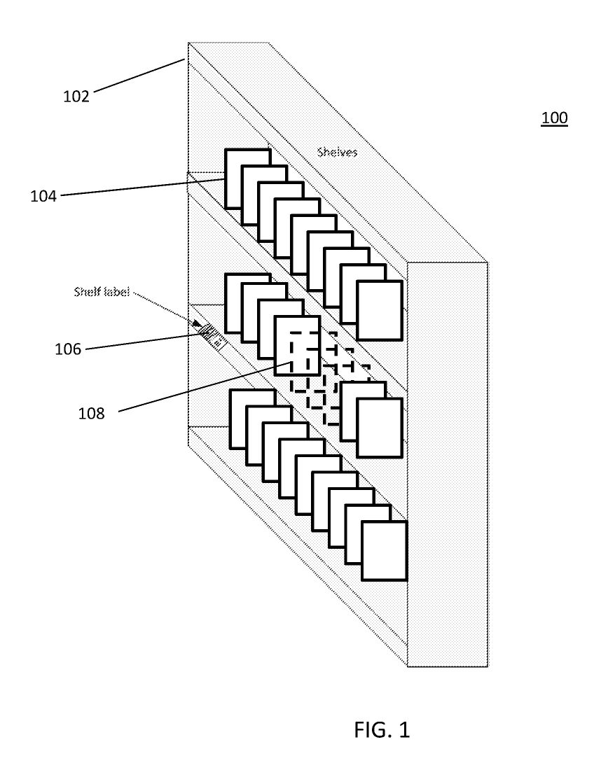

FIG. 1 is a block diagram illustrating physical objects 104 disposed on a shelving unit 102 in a facility 100 according to an exemplary embodiment of the present disclosure. Physical objects 104 can be disposed on shelves 103 of the shelving unit 102. Each shelf can have areas for displaying or storing sets of like physical objects. Labels 106 can be disposed on the front faces of the shelves to identify the areas at which the sets of like physical objects are expected to be displayed or stored. The labels 106 can include alphanumeric text and/or machine-readable elements encoded with identifiers associated with the physical objects 104. The machine-readable elements can be scanned and read by an optical scanner. The shelves 103 can include vacant areas 108 at which physical objects are absent. While FIG. 1 depicts a shelving unit, in accordance with exemplary embodiments, physical objects can be display on various fixtures including, but not limited to, shelving units, racks, baskets, pallets, bins, and/or any other suitable fixtures. The shelving units 103, or more generally the fixtures, can be distributed throughout a facility and can be used for various purposes. For example, a facility can be segmented into a front room or sales floor and a back or stock room. Fixtures in the front room can be used to display the physical objects for consumption, while the fixtures in the back room can be used to store physical objects (e.g., before they are moved to the front room).

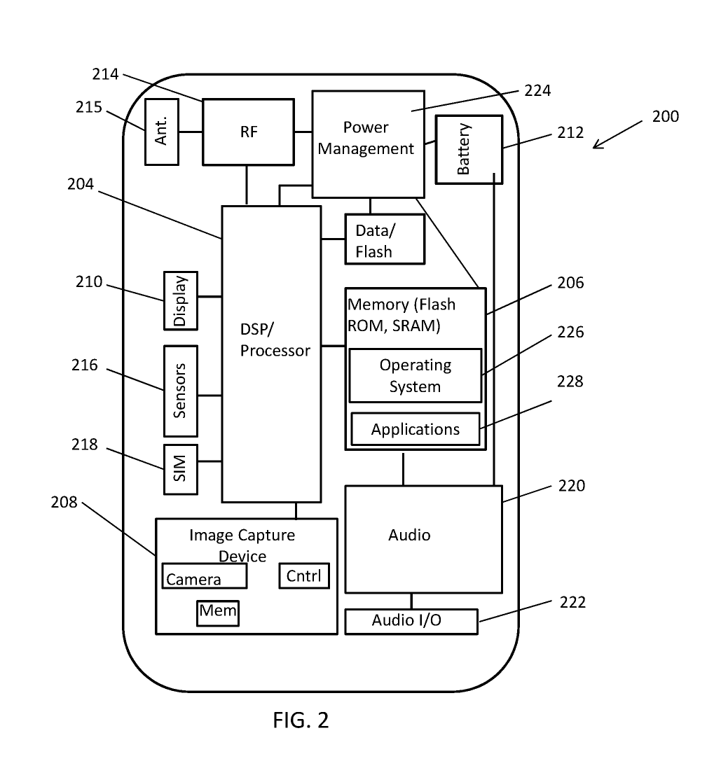

FIG. 2 is a block diagram of a portable electronic device 200 that can be utilized to implement and/or interact with embodiments of an augmented display system. The portable electronic device 200 can be a mobile device. For example, the portable electronic device 200 can be a smartphone, tablet, subnotebook, laptop, personal digital assistant (PDA), and/or any other suitable mobile device that can be programmed and/or configured to implement and/or interact with embodiments of the augmented display system. The portable electronic device 200 can include a processing device 204, such as a digital signal processor (DSP) or microprocessor, memory/storage 206 in the form a non-transitory computer-readable medium, an image capture device 208, a touch-sensitive display 210, a battery 212, and a radio frequency transceiver 214. Some embodiments of the portable electronic device 200 can also include other common components, such as sensors 216, subscriber identity module (SIM) card 218, audio input/output components 220 and 222 (including e.g., one or more microphones and one or more speakers), and power management circuitry 224.

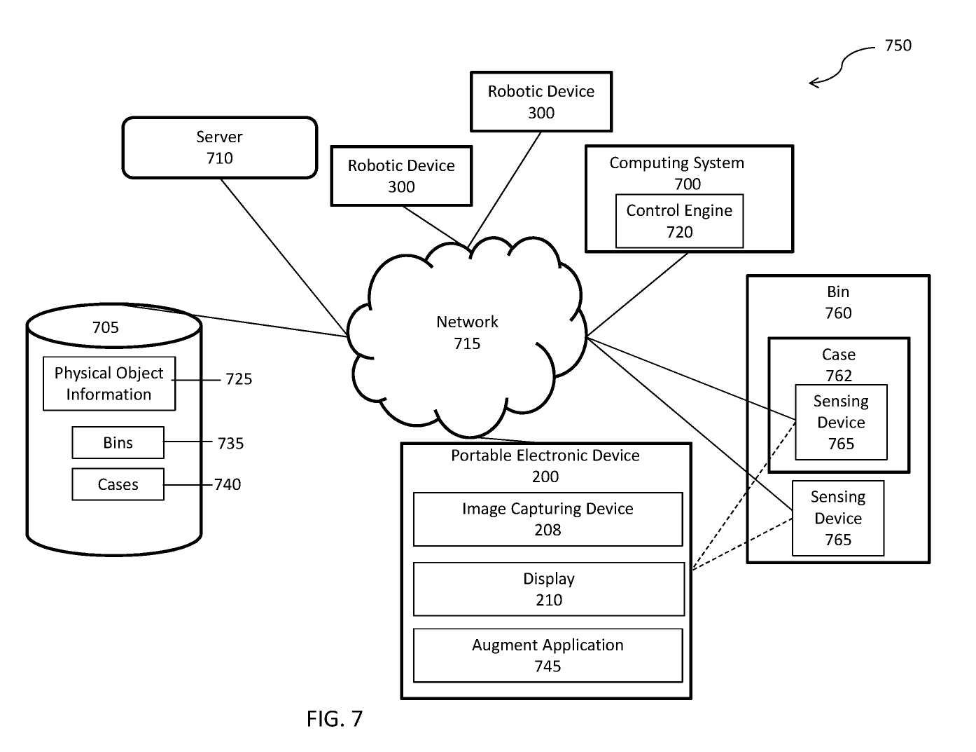

The memory 206 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 226 and applications 228 can be embodied as computer-readable/executable program code stored on the non-transitory computer-readable memory 206 and implemented using any suitable, high or low level computing language and/or platform, such as, e.g., Java, C, C++, C#, assembly code, machine readable language, and the like. In some embodiments, the applications 228 can include an assistance application configured to interact with the microphone, a web browser application, a mobile application specifically coded to interface with a computing system. The computing system is described in further detail with respect to FIG. 7. While memory is depicted as a single component those skilled in the art will recognize that the memory can be formed from multiple components and that separate non-volatile and volatile memory devices can be used.

The processing device 204 can include any suitable single- or multiple-core microprocessor of any suitable architecture that is capable of implementing and/or facilitating an operation of the portable electronic device 200. For example, to perform an image capture operation, capture a voice input of the user (e.g., via the microphone), transmit messages including a captured image and/or a voice input and receive messages from a computing system, display data/information including GUIs of the user interface 210, captured images, voice input transcribed as text, and the like. The processing device 204 can be programmed and/or configured to execute the operating system 226 and applications 228 to implement one or more processes to perform an operation. The processing device 204 can retrieve information/data from and store information/data to the storage device 206.

The RF transceiver 214 can be configured to transmit and/or receive wireless transmissions via an antenna 215. For example, the RF transceiver 214 can be configured to transmit data/information, such as input based on user interaction with the portable electronic device. The RF transceiver 214 can be configured to transmit and/or receive data/information having at a specified frequency and/or according to a specified sequence and/or packet arrangement.

The touch-sensitive display 210 can render user interfaces, such as graphical user interfaces to a user and in some embodiments can provide a mechanism that allows the user to interact with the GUIs. For example, a user may interact with the portable electronic device 200 through touch-sensitive display 210, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 212 can be implemented as a battery or capacitive elements configured to store an electric charge and power the portable electronic device 200. In exemplary embodiments, the power source 212 can be a rechargeable power source, such as a battery or one or more capacitive elements configured to be recharged via a connection to an external power supply.

A user can operate the portable electronic device 200 in a facility, and the graphical user interface can automatically be generated in response executing an augment application on the portable electronic device 200. The augment application can be associated with the facility. The image capturing device 208 can be configured to capture still and moving images and can communicate with the executed application. The touch-sensitive display 210 can render the area of the facility viewable to the image capturing device 208. The port able electronic device can be positioned so that the bins and/or cases can be within a viewable area of the image capturing device 208. The graphical user interface can render the bins and/or cases with virtual elements superimposed on the bins and/or cases.

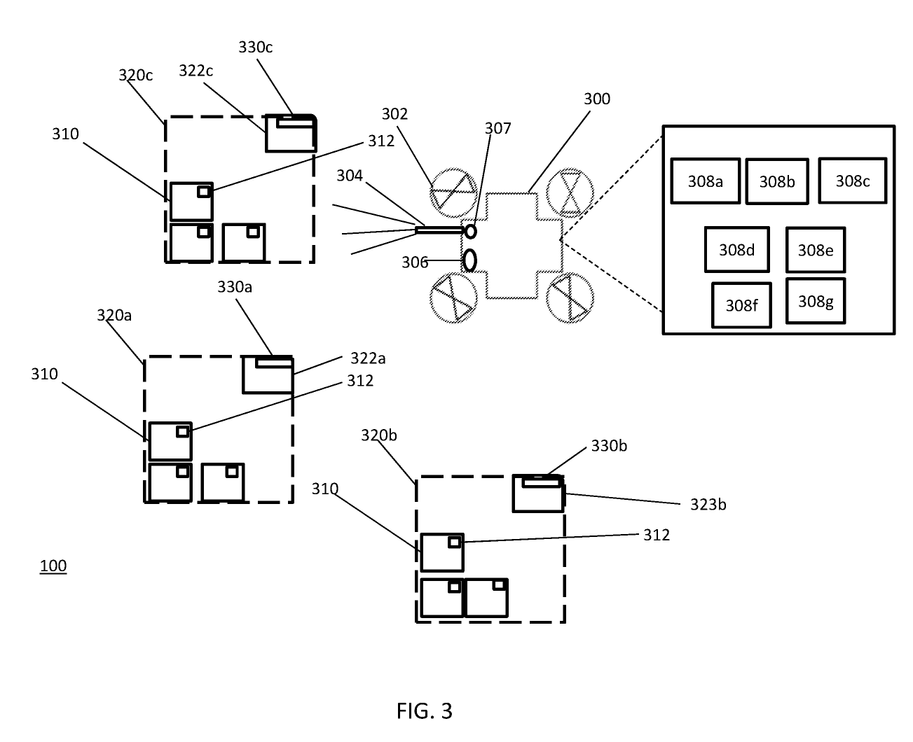

FIG. 3 is a block diagram illustrating an autonomous robot device 300 in an autonomous marking system according to exemplary embodiments of the present disclosure. The autonomous robot device 300 can be a driverless vehicle, an unmanned aerial craft, and/or the like. Embodiments of the autonomous robot device 300 can include motive assemblies 302, a dispensing instrument 304, an actuator 305 coupled to the dispensing instrument 304, image capturing device 306, a controller 308a, an optical scanner 308b, a drive motor 308c, a GPS receiver 308d, an RF transceiver 308e, accelerometer 308f, a gyroscope 308g and a power source (e.g., a battery), and can be configured to autonomously roam through a facility. The autonomous robot device 300 can be an intelligent device capable of performing tasks without human control or intervention. The dispensing instrument 304 can be one or more of adhesive, friction-based, rivet-based, hook, injecting device, gravity, or melding method by which items are affixed to each other. The dispensing instrument 304 can dispense, affix, or inject a label, liquid or solid material that will leave a visible spot, chalk dash, check, RFID chip, other electronic tag, pin, tack, a staple, or other tag of a particular shape or color that conveys information. The dispensing instrument 304 may telescope or unfold to extend outward when in use and retract when not in use

The controller 308a can be programmed to control an operation of the actuator 305 of the dispensing instrument 304, the image capturing device 306, the optical scanner 308b, the drive motor 308c, the motive assemblies 302 (e.g., via the drive motor 308c), based on various inputs including inputs from the GPS receiver 308d, the accelerometer 308e, the gyroscope 308f, the image capturing device 306, the optical scanner 308, and/or from a remote computing system. The drive motor 308c can control the operation of the motive assemblies 302 directly and/or through one or more drive trains (e.g., gear assemblies and/or belts). The power source can power the motive assemblies 302, the dispensing instrument 304, the actuator 305 coupled to the dispensing instrument 304, the image capturing device 306, the controller 308a, the optical scanner 308b, the drive motor 308c, the GPS receiver 308d, RF transceiver 308e, the accelerometer 308f, the gyroscope 308g.

In this non-limiting example, the motive assemblies 302 can be rotors and blades affixed to the edges of the autonomous robot device 300. Other examples of the motive assemblies 302 can be, but are not limited to, wheels, tracks, and propellers. The motive assemblies 302 can facilitate 360 degree movement for the autonomous robot device 302. The image capturing device 305 can be a still image camera or a moving image camera.

The GPS receiver 308d can be an L-band radio processor capable of solving the navigation equations in order to determine a position of the autonomous robot device 300, determine a velocity and precise time (PVT) by processing the signal broadcasted by GPS satellites. The accelerometer 308f and gyroscope 308g can determine the direction, orientation, position, acceleration, velocity, tilt, pitch, yaw, and roll of the autonomous robot device 300. In exemplary embodiments, the controller can implement one or more algorithms, such as a Kalman filter, for determining a position of the autonomous robot device.

Alternatively or in addition to, the autonomous robot device 300 can navigate around the facility using beacon devices and triangulation. Beacon devices can be disposed in the facility. The beacon device can emit a signal encoded with an identifier, indicating a location of the facility. The RF transceiver 308e disposed on the autonomous robot device 300 can extract the unique identifier from the signal emitted by the beacon device, in response to the autonomous robot device 300 being within a specified distance of the beacon device. In response to extracting the identifier, the autonomous robot device 300 can determine its location within the facility.

The autonomous robot device 300 can navigate around a specified location of a facility and scan cases 310a-b containing one or more physical objects. The cases 310a-b can be disposed in fixtures 320a-c, respectively, which, in this non-limiting example, can correspond to bins disposed in the back room of a facility. For example, the cases 310a-b can be stacked on top of one another within the bins 320a-c or can be stacked back-to-back or side-to-side. Each of the bins 320a-c can be identified by labels 322a-c including alphanumeric text and/or machine-readable elements 330a-c disposed on the bins 320a-c, respectively. The machine-readable elements 330a-c can be encoded with identifiers associated with the respective bin 320. Labels 312 can be disposed on each of the cases 310. The labels 312 can include information associated with the physical objects disposed within the cases. The information can include name, type, color, size, quantity and/or a machine-readable element encoded with an identifier associated with the physical objects.

The autonomous robot device 300 can navigate through the specified location of the facility (e.g., the back room) using the motive assemblies 302 to the bins 320a-c. The autonomous robot device 300 can be programmed with a map of the facility and/or can generate a map of facility using simultaneous localization and mapping (SLAM). The autonomous robot device 300 can navigate around the facility based on inputs from the motive assemblies 302, GPS receiver 308d, RF transceiver 308e, the accelerometer 308f, the gyroscope 308g.

The autonomous robot device 300 can scan the labels 312 disposed on the cases 310 using the image capturing device 306. The image capturing device 306 can extract and decode the information on the labels 322a-c on the bins 320a-c and/or the labels on the bins 312, and the autonomous robot device 300 can transmit the information to a computing system. The autonomous robot device 300 can use optical character recognition or machine-vision to extract and decode the information from the labels. In other embodiments, the autonomous robot device can capture an image of the labels 312 and transmit the image to the computing system. The computing system will be described in further detail with respect to FIG. 7.

The autonomous robot device 300 can receive instructions for identified cases at the bins 320a-c indicating a priority with which the cases are to be moved to a fixture in another location (e.g., the front room) in the facility 100. The autonomous robot device 300 can scan and locate the identified cases 310 within the bins 320 using the image capturing device. The actuator 305 can actuate the dispensing device 304 to mark the identified cases with a specified identifying mark, such as a dot, glyph, shape, character, or the like, and/or can be one or more colors. In addition, or alternatively, the autonomous robot device 300 can mark the bin corresponding to the cases with the identifying mark. Different identifying marks can correspond to different actions or tasks to be performed with respect to the marked cases 310. In one embodiment, the dispensing device 304 can be a paint dispenser and the identifying mark can be a particular color of paint, dispensed from the paint dispenser. For example, a green color can represent high priority, black can represent intermediate priority and red can represent low priority for moving physical objects from the bins 320 to fixtures at another location. In one embodiment, the paint dispenser can dispense the paint to be a particular shape, identifying mark, glyph, character, or the like, and/or can mark the bins or cases with the quantity of physical objects to be moved.

In another embodiment the dispensing device 304 can be a laser and the identifying mark can be an inscription indicating the priority and/or quantity. In another embodiment, the dispensing device 304 can dispense stickers marking the cases 310. The actuator 305 can be coupled to a compressed air device. In response, the actuator 305 being actuated compressed air can be released to force a sticker out of the dispensing device 304, and onto the cases 310 and/or bins. The dispensing device 304 can also include a writing instrument (i.e., chalk, graphite, ink). The dispensing device 304 can write an identifying mark on the identified cases 310 and/or bins, using the writing instrument.

In one embodiment, the autonomous robot device 300 can scan and decode the identifier from the machine-readable elements 230a-c of the bins 320a-c. The autonomous robot device 300 can transmit the identifiers to the computing system. The autonomous robot device 300 can receive instructions to mark specified cases 310 within each of the bins 320a-c, with an identifying mark. The autonomous robot device can search and locate the specified cases 310 within the bins 320a-c and mark the specified cases 310, with a specified identifying mark. In the event, the specified case is not visible to the autonomous robot device 300, the autonomous robot device 300 can mark the outside of the bin 320a-c, with a specified identifying mark.

In one embodiment, the autonomous robot device 300 can extract and decode information disposed on the outside of a bin 320a-c, using the image capturing device 306. Alternatively or in addition to, the autonomous robot device 300 can capture an image using the image capturing device 306 and transmit an image of the information disposed on the outside of the bin 320a-c to the computing system. As described above, the autonomous robot device can use OCR and machine-vision to extract and decode the information. The information can include identifying information of cases disposed within the bins 320a-c (e.g., including a quantity of cases and/or a quantity of physical objects in the bins). The autonomous robot device 300 can transmit the extracted and decoded information to the computing system. The autonomous robot device 300 can receive instructions to mark specified cases 310 within each of the bins 320a-c, with a specified identifying mark. The autonomous robot device can search and locate the specified cases 310 within the bins 320a-c and mark the specified cases 310. In the event, the specified case is not visible to the autonomous robot device 300, the autonomous robot device 300 can mark the outside of the bin 320a-c, with a specified identifying mark. The autonomous robot device 300 can mark portions of the information disposed on the outside of the bins 320a-c to identify the priority determined for the cases.

In one embodiment, the cases 310a-b can be stacked on top of each other in the bins 320a-c. The autonomous robot device 300 can use Lidar technology using a sensor to locate and scan cases which are disposed underneath other cases. The sensor can be configured to illuminate the cases using pulsed laser light and measuring the reflected pulses.

In one embodiment, the autonomous robot device 300 can transmit information associated with bins 320a-b and/or cases 310a-c which are disposed at facilities to a computing system. The information can include extracted text, images and/or identifiers of the bins 320a and/or cases 310a-c. The computing system can determine an identifying mark associated with the bins 320a-b and/or cases 310a-c. The computing system can convert the identifying mark into a virtual element and store and associate the virtual element with an identifier associated with a bins 320a and/or cases 310a-c on which the virtual element is to be superimposed.

In one embodiment, the autonomous robot device 300 can embed a sensing device in the bins 320a-b and/or cases 312a-b. The sensing device can be encoded with an identifier. The autonomous robot device 300 can transmit information associated with bins 320a-b and/or cases 310a-c which are disposed at facilities and the identifier of the sensing device to a computing system. The information can include extracted text, images and/or identifiers of the bins 320a and/or cases 310a-c. The computing system can determine an identifying mark associated with the bins 320a-b and/or cases 310a-c. The computing system can store and associate the identifier of the sensing device with the identifying mark and respective the bins 320a-b and/or cases 310a-c. As a non-limiting example, the sensing device can be one or more of a RFID tag, other electronic tag, pin, tack, or staple.

The sensing device can be scanned and/or detected by a portable electronic device (e.g., portable electronic device 200 as shown in FIG. 2). In response to the sensing device being scanned or detected by a portable electronic device, the portable electronic device can transmit a decoded identifier associated with the respective identifying mark to the computing system. The computing system can instruct the portable electronic device to render the identifying mark associated with the identifier on the display.

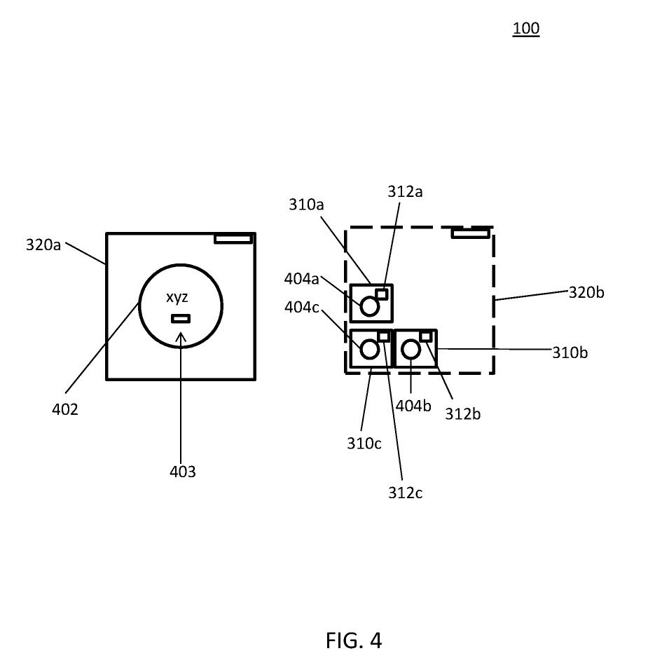

FIG. 4 is a block diagram of marked bins and cases in accordance with an exemplary embodiment. As described herein, embodiments of the autonomous robot device (e.g., autonomous robot device 300 as shown in FIG. 3) can mark a bin 320a or cases 310a-c disposed within a bin 320b, with a specified identifying mark. The identifying mark 402 can be disposed outside the bin 320a. The identifying mark 402 disposed outside a bin 320a can indicate information 403 identifying cases and priority of the physical objects disposed in the identified cases disposed within the bin 320a to be placed on shelving units in a different location in the facility.

The autonomous robot device 300 can also place identifying marks 404a-c on cases 310a-c disposed within a bin 320b. For example, the identifying mark 404a can be placed on the case 312a, the identifying mark 404b can be placed on the case 312b, the identifying mark 304c can be placed on case 312c. Each of the identifying marks 404a-c can indicate a different level of priority of the physical objects disposed in the cases 310a-c to be placed on the shelving units in a different location in the facility.

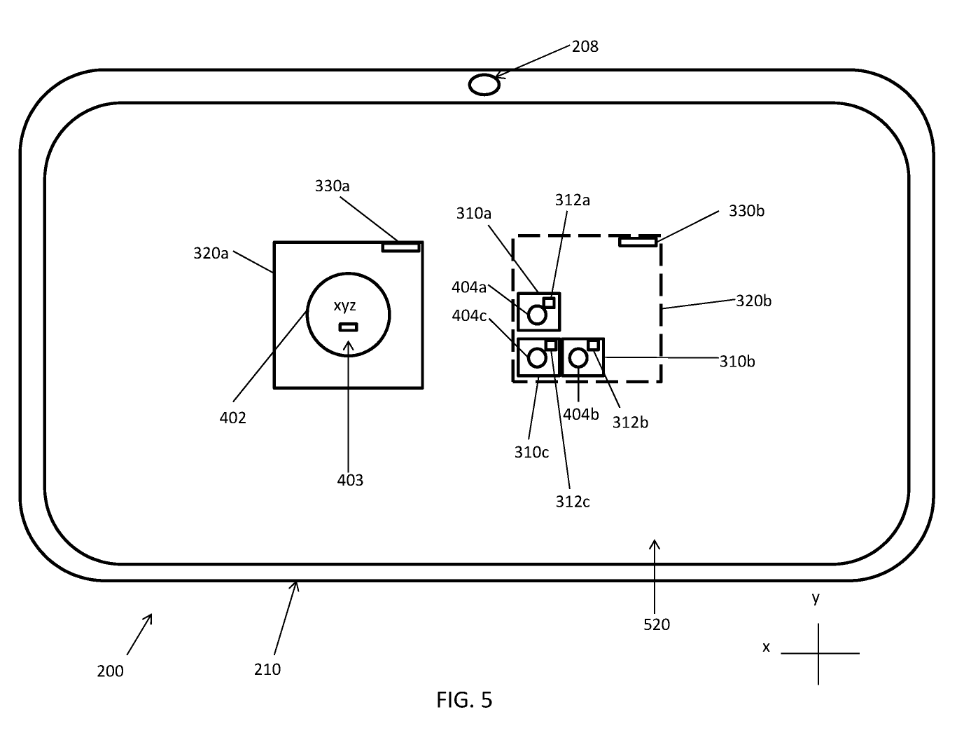

FIG. 5 is a schematic diagram of a portable electronic device 200 depicting a virtual element superimposed on bins and/or cases according to an exemplary embodiment. The portable electronic device 200 can include the image capturing device 208 and the touch-sensitive display 210. The image capturing device 208 can capture still or moving images. The image capturing device 208 can be disposed on the front or rear of the portable electronic device 200. The touch-sensitive display 210 can display the physical scene 520 in the field of view of the image capturing device 208 as it is being captured.

In exemplary embodiment, the portable electronic device 200 can execute the augment application to instruct the portable electronic device 200 to power on the image capturing device 208 and control the operation of the image capturing device 208. An exemplary embodiment of the augment application is described herein with reference to FIG. 7. In response to powering on, a lens and optical sensor of the image capturing device 208 can become operational. The image capturing device 208 can be pointed at a physical scene 520; viewable to the lens and optical sensor, and the physical scene 520 being captured by the optical sensor can be rendered on the touch-sensitive display 210. The image capturing device 208 can zoom, pan, capture and store the physical scene 520. For example, the physical scene 520 can include the bin 320a or cases 310a-c.

In one embodiment, in response to pointing the image capturing device 208 at a physical scene 520 for more than a specified amount of time (e.g., an amount of time the image capturing device captures the same scene—with minor variations/movement—exceeds a specified threshold), the image capturing device 208 can detect attributes associated with the physical scene 520. For example, the physical scene 220 can include the bin 320a or cases 310a-c, the image capturing device 208 can detect attributes (e.g. shapes, sizes, dimensions etc.) of a physical item in the physical space 520, such as the bins 320a-b and the corresponding alphanumeric text and/or machine-readable elements 330a-b on the respective bins 320a-b or alphanumeric text and/or machine-readable elements 312a-c on the cases 310a-c. In some embodiments, the touch-sensitive display 210 can display a visual indicator each time a physical item is detected. For example, the visual indicator can be a box superimposed around the physical item. The portable electronic device 100 can correlate the detected bins 320a-b and/or cases 310a-c and the corresponding alphanumeric text and/or machine-readable elements 330a-b on the respective bins 320a-b or alphanumeric text and/or machine-readable elements 312a-c on the cases 310a-c.

In one embodiment, the image capturing device 108 can transmit the detected alphanumeric text and/or machine-readable elements 330a-b on the respective bins 320a-b or alphanumeric text and/or machine-readable elements 312a-c on the cases 310a-c to a computing system. In response to receiving instructions from the computing system, the portable electronic device 200 can augment the physical scene 520 by superimposing a virtual element such as an identifying mark 402 and/or 404a-c on the bin 320a or cases 310a-c. The portable electronic device 200 can determine the coordinates along the X and Y axis on the display screen, of the location 210 in the viewable area to accurately position the virtual element on the bins 320a-b and/or cases 310a-c.

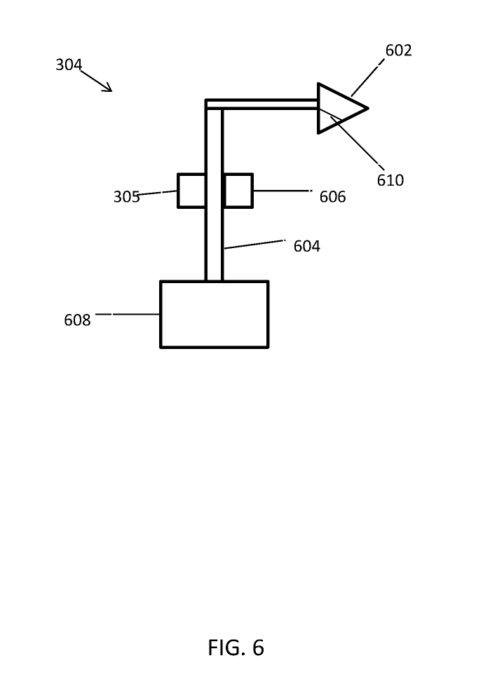

FIG. 6 is a block diagram of the dispensing device in accordance with an exemplary embodiment. The dispensing device 304 can include a nozzle 602, a tube 604, an actuator 305, a pump 606, and a reservoir 608. The nozzle 602 can include an opening. The reservoir 408 can store materials to be dispensed. For example, the reservoir 608 can include paint of various colors. The in response to the pump 606 being actuated by the actuator 608, the reservoir 608 can expel up the tube 404 and dispensed through an opening of the nozzle 602. Continuing with the example, different colors of paint can be dispensed through the nozzle 602.

Alternatively, or in addition to, a writing instrument 610 can be disposed within the nozzle. The writing instrument 610 can be in a retracted position inside in the nozzle 602. The writing instrument 610 can extend out of the nozzle 602. The writing instrument 610 can be chalk, marker, pen and/or pencil.

FIG. 7 illustrates an exemplary autonomous marking system 750 in accordance with an exemplary embodiment. The autonomous marking system 750 can include one or more databases 705, one or more servers 710, one or more computing systems 700, sensing devices 765, portable electronic devices 200, and autonomous robotic devices 300. In exemplary embodiments, the computing system 700 can be in communication with the databases 705, the server(s) 710, the autonomous robotic devices 300, sensing devices 765, and the portable electronic devices 200, via a communications network 715. The computing system 700 can execute a control engine 720 to implement the autonomous marking system 750. As stated above, the sensing device 765 can be one or more of a RFID tag, other electronic tag, pin, tack, or staple.

In an example embodiment, one or more portions of the communications network 715 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 710 includes one or more computers or processors configured to communicate with the computing system 700, the portable electronic devices 200, the autonomous robotic devices 300, sensing devices 765, and the databases 705, via the network 715. The server 710 hosts one or more applications configured to interact with one or more components computing system 700 and/or facilitates access to the content of the databases 705. The databases 705 may store information/data, as described herein. For example, the databases 705 can include physical objects database 725 and a bins database 735. The physical objects database 725 can store information associated with physical objects disposed at a facility and can be indexed via the decoded identifier retrieved by the identifier reader. The bins database 735 can store information associated with bins and cases stored within the bins. The cases database 740 can store information associated with cases and physical objects stored within the cases. The databases 705 can be located at one or more geographically distributed locations from the computing system 700. Alternatively, the databases 705 can be located at the same geographically as the computing system 700.

In one embodiment, bins 760 housing cases 762 can be disposed in a facility. The bins 760 and cases 762 can embody, e.g., bins 320a-c as shown in FIGS. 3-4, and cases 310, 310a-c as shown in FIGS. 3-4. An autonomous robot device 300 can transmit information associated with cases 762 disposed in bins 760 which are disposed at facilities to the computing system 700. The computing system 700 can execute the control engine 720 in response to receiving the information associated with the cases 762. The information can include extracted text, images and/or identifiers of the cases. In the event, the computing system 700 receives images, the control engine 720 can use optical character recognition (OCR) or machine-vision to extract identifying information associated with the cases. In the event the computing system 700 receives a machine-readable element, the control engine 700 can decode an identifier associated the cases from the machine-readable element. The control engine 720 can query the cases database 740 using the information received from the autonomous robot device 300, to retrieve information associated with physical objects stored in the cases 762. The control engine 720 can query the physical objects database 725 to retrieve information associated with the physical objects stored in the cases 762. The information can include, name, type, color, quantity of physical objects in the cases, and a quantity of physical objects disposed on shelving units in a different location in the facility.

The control engine 720 can determine a priority for the physical objects disposed in one or more cases to be moved from the cases 762 and placed on the shelving units. The control engine 720 can instruct the autonomous robot device 200 to mark the identified one or more cases 762 with an identifying mark respective to the determined priority. As an example, the control engine 720 can determine a case contains a set of like physical objects. A quantity of the same like physical objects disposed on the shelving units is lower than a threshold amount. The control engine 720 can determine that the case 762 containing the set of like physical objects should be marked with an identifying mark indicating high priority to move the physical objects from the case 762 and placed on the shelving units. The identifying mark can also indicate a date or time at which the products should be moved from the cases 762 to the shelving units.

In one embodiment, the identifying mark can change color, shape, and/or size over time to indicate a change in priority. For example, the control engine 720 can determine a set of like physical objects will be absent from shelving units in 4 weeks from the present date. The identifying mark can change as the date approaches the 4^{th} week and the physical objects are expected to be absent from the shelving unit.

In one embodiment, the computing system 700 can receive a decoded identifier associated with a bin 760 from an autonomous robot device 200. In another embodiment, the computing system 700 can receive an image of information disposed on the outside of a bin 760. The control engine 720 can use OCR and/or machine-vision to extract identifying information associated with the bin. The control engine 720 can query the bins database 735 using the identifier to retrieve information associated with the cases 762 within the bin using identifier received from the autonomous robot device 700, to retrieve information associated with the cases 762 within the bin 760. The control engine 720 can query the cases database 740 using the information associated with the cases 762, to retrieve information associated with physical objects disposed in the cases 762. The control engine 720 can query the physical objects database 725 to retrieve information associated with the physical objects stored in the cases 762.

The control engine 720 can determine a priority for the physical objects disposed in one or more cases 762 to be moved from the cases and placed on the shelving units. The control engine 720 can instruct the autonomous robot device 200 to mark the bins in which identified one or more cases are disposed, with a specified identifying mark. The identifying mark can include information associated with the one or more cases and the priority for each of the cases 762.

In one embodiment, identifying marks can be embodied as virtual elements to be superimposed on the bins 760 and/or cases 762 in a virtual scene. As stated above, the autonomous robot device 300 can transmit information associated with cases 762 disposed in bins 760 which are disposed at facilities to the computing system 700. The computing system 700 can execute the control engine 720 in response to receiving the information associated with the cases. The information can include extracted text, images and/or identifiers of the bins 760 and/or cases 762. The control engine 720 can query the bins database 735 and/or cases database 740 using the information received from the autonomous robot device 300, to retrieve information associated with physical objects stored in the cases 762. The control engine 720 can query the physical objects database 725 to retrieve information associated with the physical objects stored in the cases. The information can include, name, type, color, quantity of physical objects in the cases, and a quantity of physical objects disposed on shelving units in a different location in the facility.

The control engine 720 can determine a priority and/or urgency for the physical objects disposed in one or more cases to be moved from the cases 762 and placed on the shelving units. For example, the control engine 720 can determine that the physical objects are absent from the shelving units and immediately need to be moved from the cases 762 to the shelving units. The control engine 720 can determine an identifying mark associated with the determined priority. The control engine 720 can convert the identifying mark into a virtual element and store the virtual element in the bins database 735 and/or cases database 740 and associate the virtual element with an identifier associated with a bin 760 or case 762 on which the virtual element is to be superimposed.

The portable electronic device 200 can execute an augment application 745. In response to pointing the image capturing device 208 of the portable electronic device 200 at a physical scene 520 including the bins 760 and/or cases 762, the image capturing device 208 can detect attributes (e.g. shapes, sizes, dimensions etc.) of a physical item in the physical space, such as the bins 760 and/or cases 762 and the corresponding alphanumeric text and/or machine-readable elements on the respective bins 760 or alphanumeric text and/or machine-readable elements on the cases 762. In some embodiments, the touch-sensitive display 210 can display a visual indicator each time a physical item is detected. For example, the visual indicator can be a box superimposed around the image of the physical item rendered on the display. The portable electronic device 100 can correlate the detected bins 760 and/or cases 762 and the corresponding alphanumeric text and/or machine-readable elements on the respective bins 760 or alphanumeric text and/or machine-readable elements on the cases 762.

The portable electronic device 200, via the augment application 745 can transmit the detected alphanumeric text and/or machine-readable elements on the respective bins 760 or alphanumeric text and/or machine-readable elements on the cases 762 to the computing system 700. The control engine 720 can query the bins database 735 and/or the cases database 740 using the received identifier(s) decoded from the alphanumeric text and/or machine-readable elements on the respective bins 760 or alphanumeric text and/or machine-readable elements on the cases 762, to retrieve the respective virtual element associated with the identifier. In one embodiment, the augment application 745 can decode the identifiers from the alphanumeric text and/or machine-readable elements. Alternatively, the control engine 720 can decode the identifiers from the alphanumeric text and/or machine-readable elements. The control engine 720 can transmit instructions to the portable electronic device 200 to augment the display of the physical scene rendered on the touch-sensitive display 210 by superimposing the retrieved virtual element corresponding to each identifier(s). In response to receiving instructions from the computing system, the augment application 745 of the portable electronic device 200 can augment the physical scene by superimposing a virtual element such as an identifying mark on the bin 760 and/or cases 762.

In one embodiment, the autonomous robot device 300 can embed a sensing device 765 in the bins 760 and/or cases 762. The sensing device 765 can be encoded with an identifier. The autonomous robot device 300 can transmit information associated with bins 760 and/or cases 762 which are disposed at facilities and the identifier of the sensing device to the computing system 700. The information can include extracted text, images and/or identifiers of the bins 760 and/or cases 762. The control engine 720 can determine an identifying mark associated with the bins 760 and/or cases 762. The control engine 720 can store and associate the identifier of the sensing device with the identifying mark and respective the bins 760 and/or cases 762 in the bins database 735 and/or cases database 740.

The sensing device 765 can be scanned and/or detected by a portable electronic device 200. In response to the sensing device being scanned or detected by a portable electronic device 200, the portable electronic device 200 can transmit a decoded identifier of the sensing device to the computing system 700. The control engine 720 can query the bins database 735 and/or cases database 740 using the identifier to retrieve the identifying mark associated with the identifier of the sensing device and respective bin 760 or case 762. The control engine 720 can instruct the portable electronic device 200 to render the identifying mark associated with the identifier of the sensing device and respective bin 760 or case 762 on the touch-sensitive display 210.

As a non-limiting example, the automated robotic marking system 750 can be implemented in a retail store. Products can be disposed on shelving units on the sales floor. Products can also be disposed in cases 762 disposed in bins 760 located in the in a storage/stocking room. As an example, a retail store may have a rule to stock shelving units after a specified amount of products are remaining on the shelves. The products can be moved from the cases 762 in the stock/storage room to the shelving units. The automated robotic marking system 750 can determine a timeframe and/or priority at which products should be restocked on the shelving units. As an example, the control engine 720 can use on-hand data and rate of sales data retrieved from a POS system in the retail store to determine if the product has been put on the shelves.

The computing system 700 can execute the control engine 720 in response to receiving the information associated with the cases from the autonomous robot device 200. The control engine 720 can query the cases database 740 using the information received from the autonomous robot device 700, to retrieve information associated with physical objects stored in the cases. The control engine 720 can query the physical objects database 725 to retrieve information associated with the products stored in the cases 762. The information can include, name, type, color, quantity of products in the cases, and a quantity of products disposed on shelving units on the sales floor.

The control engine 720 can determine a priority for the products to be re-stocked from the storage/stock room to the shelving units on the sales floor. The control engine 720 can instruct the autonomous robot device 200 to mark the identified one or more cases 762 with an identifying mark respective to the determined priority. As an example, the control engine 720 can determine a case contains bottles of Pepsi®. The control engine 720 can also determine the Pepsi® bottles stock on the shelving units is lower than a threshold amount. The control engine 720 can determine that the case containing the set of like physical objects should be marked with an identifying mark indicating high priority to move the Pepsi® bottles from the case and placed on the shelving units.

As described above, in one embodiment the sensing device 765 can be embedded into the bins 760 and/or cases 762. The sensing device 765 can include a location module configured to determine the location of the sensing device 765. The sensing device 765 can periodically provide its location to the computing system 700. The control engine 720 can track the location of the bins and/or cases 762 based on the location information received from the sensing device 765. The control engine 720 can determine whether the items in the cases which need to be stocked have been stocked on the shelving units based on the location information of the sensing devices 765.

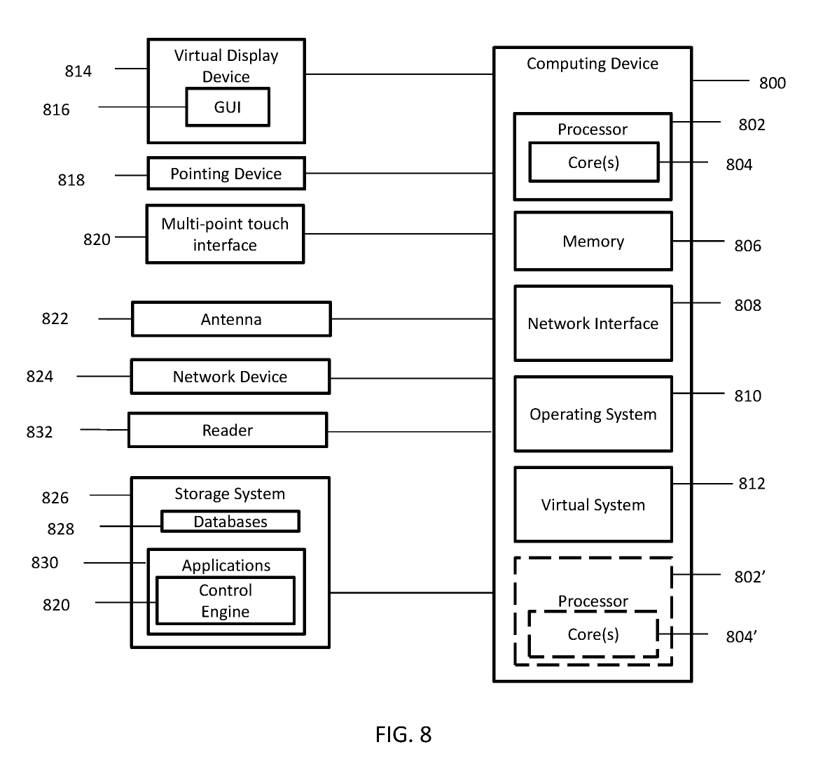

FIG. 8 is a block diagram of an example computing device for implementing exemplary embodiments. The computing device 800 may be, but is not limited to, a smartphone, laptop, tablet, desktop computer, server or network appliance. The computing device 800 can be embodied as part of the computing system. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 806 included in the computing device 800 may store computer-readable and computer-executable instructions or software (e.g., applications 830 such as the control engine 720) for implementing exemplary operations of the computing device 800. The computing device 800 also includes configurable and/or programmable processor 802 and associated core(s) 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for implementing exemplary embodiments. Processor 802 and processor(s) 802′ may each be a single core processor or multiple core (804 and 804′) processor. Either or both of processor 802 and processor(s) 802′ may be configured to execute one or more of the instructions described in connection with computing device 800.

Virtualization may be employed in the computing device 800 so that infrastructure and resources in the computing device 800 may be shared dynamically. A virtual machine 812 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

A user may interact with the computing device 800 through a visual display device 814, such as a computer monitor, which may display one or more graphical user interfaces 816, multi touch interface 820, a pointing device 818, a scanner 836 and a reader 832. The scanner 836 and reader 832 can be configured to read sensitive data.

The computing device 800 may also include one or more storage devices 826, such as a hard-drive, CD-ROM, or other computer readable media, for storing data and computer-readable instructions and/or software that implement exemplary embodiments (e.g., applications i.e. the control engine 720). For example, exemplary storage device 826 can include one or more databases 828 for storing information regarding physical objects, cases and bins. The databases 828 may be updated manually or automatically at any suitable time to add, delete, and/or update one or more data items in the databases.

The computing device 800 can include a network interface 808 configured to interface via one or more network devices 824 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 822 to facilitate wireless communication (e.g., via the network interface) between the computing device 800 and a network and/or between the computing device 800 and other computing devices. The network interface 808 may include a built-in network adapter, network interface card, PCMCIA network card, card bus network adapter, wireless network adapter, USB network adapter, modem or any other device suitable for interfacing the computing device 800 to any type of network capable of communication and performing the operations described herein.

The computing device 800 may run operating system 810, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device 800 and performing the operations described herein. In exemplary embodiments, the operating system 810 may be run in native mode or emulated mode. In an exemplary embodiment, the operating system 810 may be run on one or more cloud machine instances.

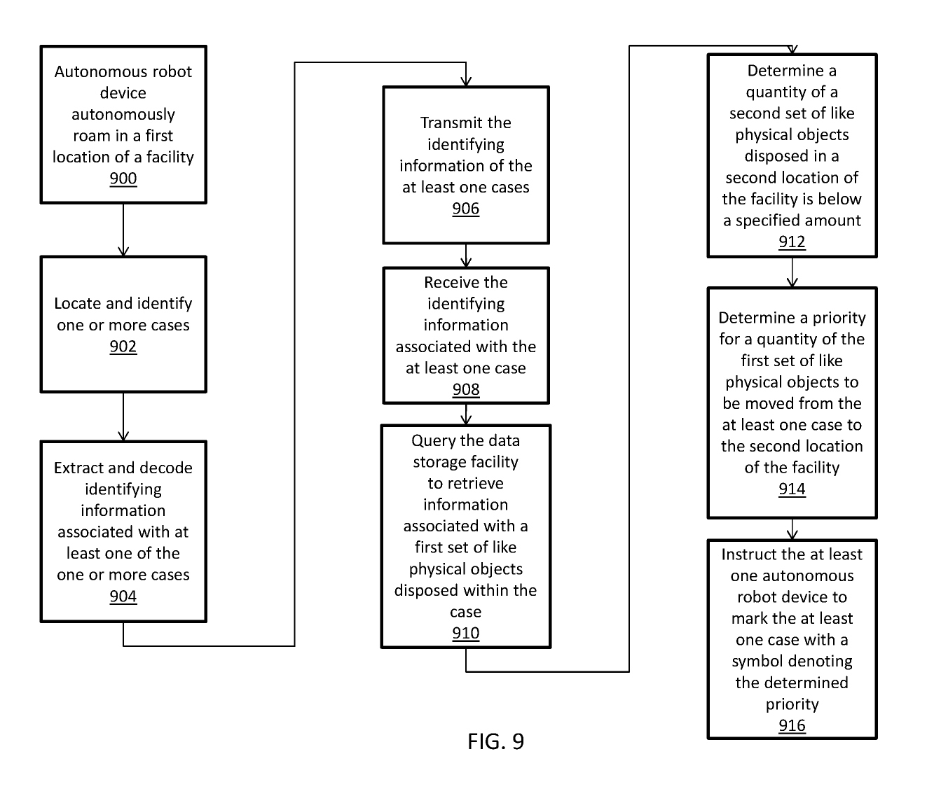

FIG. 9 is a flowchart illustrating the process of the autonomous marking system according to exemplary embodiment. In operation 900, an autonomous robot device (e.g. autonomous robot device 300 as shown in FIGS. 3 and 7) can autonomously roam in a first location of a facility. The autonomous robot device can be in selective communication with a computing system (e.g., a computing system 700 as shown in FIG. 7) via a communications network (e.g., network 715 as shown in FIG. 7). In operation 902, the autonomous robot device can locate and identify one or more cases (e.g., cases 310, 310a-c, 762 as shown in FIGS. 3-4, 7) stored in at least one of a plurality of bins (e.g., bins 320a-c, 760 as shown in FIG. 3-4, 7) in the first location of the facility, wherein each case containing a set of like physical objects (e.g. physical objects 104 as shown in FIG. 1). In operation 904, the autonomous robot device can extract and decode, via the at least one autonomous robot device, identifying information (e.g., labels 312, 312a-c as shown in FIGS. 3-4) associated with at least one of the one or more cases using the image capturing device or the reader. In operation 906, the autonomous robot device can transmit the identifying information of the at least one of the one or more cases to the computing system. In operation 908, the computing system can receive the identifying information associated with the at least one of the one or more cases. In operation 910, the computing system can query the data storage facility (e.g., the physical objects database 725, the bins database 735 and the cases database 740 as shown in FIG. 7) to retrieve information associated with a first set of like physical objects disposed within the case. In operation 912 the computing system can determine a quantity of a second set of like physical objects disposed in a second location of the facility is below a specified amount. In operation 914, the computing system can determine a priority for a quantity of the first set of like physical objects to be moved from the at least one of the one or more cases to the second location of the facility. In operation 916 the computing system can instruct the at least one autonomous robot device to mark the at least one of the one or more cases with an identifying mark denoting the determined priority.

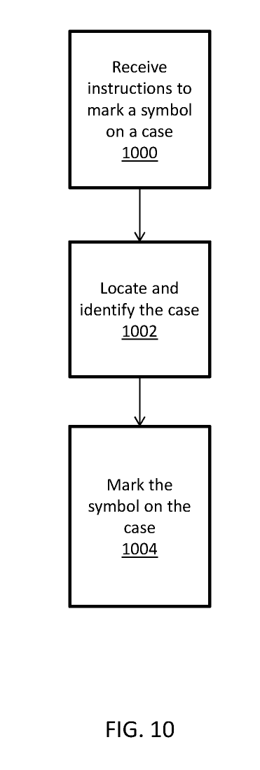

FIG. 10 is a flowchart illustrating the process of the autonomous marking system according to exemplary embodiment. In operation 1000, an autonomous robot device (e.g. autonomous robot device 300 as shown in FIGS. 3 and 7) can receive instructions to mark a identifying mark (e.g. identifying mark 402, 404a-c as shown in FIG. 4-5) on a case (e.g., cases 310, 310a-c as shown in FIGS. 3-4). In operation, 1002, the autonomous robot device can locate and identify the case. In operation 1004, the autonomous robot device can mark the identifying mark on the case using a dispensing device (e.g., dispensing device 304 as shown in FIGS. 3 and 6).

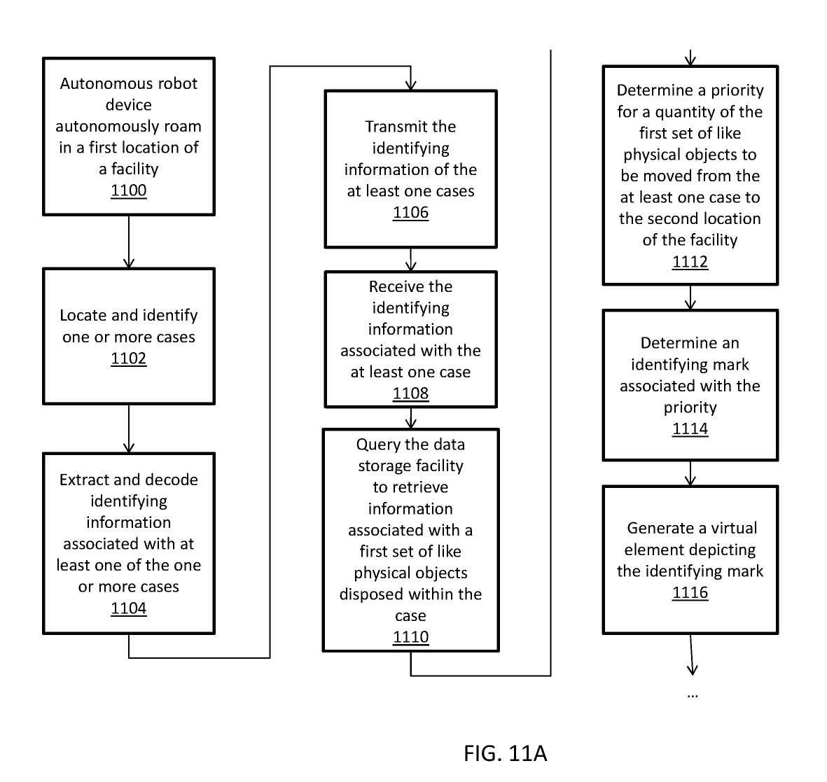

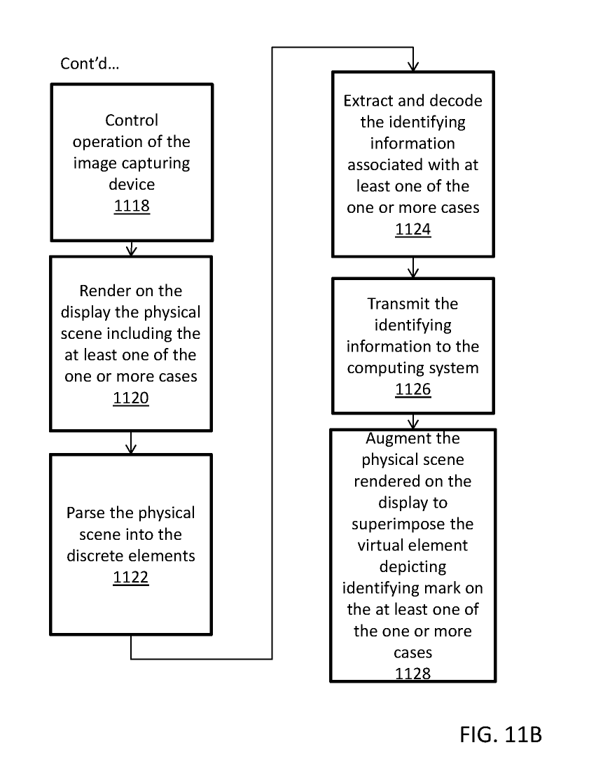

With reference to FIGS. 11A-B a flowchart illustrating the process of the autonomous marking system according to an exemplary embodiment is depicted. With reference to FIG. 11A, in operation 1100, an autonomous robot device (e.g. autonomous robot device 300 as shown in FIGS. 3 and 7) can autonomously roam in a first location of a facility. The autonomous robot device can be in selective communication with a computing system (e.g., a computing system 700 as shown in FIG. 7) via a communications network (e.g., network 715 as shown in FIG. 7). In operation 1102, the autonomous robot device can locate and identify one or more cases (e.g., cases 310, 310a-c, 762 as shown in FIGS. 3-4, 7) stored in at least one of a plurality of bins (e.g., bins 320a-c, 760 as shown in FIG. 3-4, 7) in the first location of the facility. Each case can contain a set of like physical objects (e.g. physical objects 104 as shown in FIG. 1). In operation 1104, the autonomous robot device can extract and decode, via the at least one autonomous robot device, identifying information (e.g., labels 312, 312a-c as shown in FIGS. 3-4) associated with at least one of the one or more cases using the image capturing device or the reader. In operation 1106, the autonomous robot device can transmit the identifying information of the at least one of the one or more cases to the computing system. In operation 1108, the computing system can receive the identifying information associated with the at least one of the one or more cases.

In operation 1110, the computing system can query the data storage facility (e.g., the physical objects database 725, the bins database 735 and the cases database 740 as shown in FIG. 7) to retrieve information associated with a first set of like physical objects disposed within the case. In operation 1112, the computing system can determine a priority for a quantity of the first set of like physical objects to be moved from the at least one of the one or more cases to the second location of the facility. In operation 1114, the computing system can determine an identifying mark associated with the priority. In operation 1116, the computing system can generate a virtual element depicting the identifying mark and the computing system can associate virtual element with the at least one of one or more cases in the data storage facility.

With reference to FIG. 11B, in operation 1118, control the operation of the image capturing device of a portable electronic device (e.g., portable electronic device 200 as shown in FIGS. 2, 5, 7) via an application (e.g., augment application 745 as shown in FIG. 7) executing on the portable electronic device to contemporaneously and continuously image an area within a field of view of the image capturing device. In operation 1120, execution of the application by the portable electronic device can render, on the display, the physical scene including the at least one of the one or more cases and the identifying information associated with the at least one of the one or more cases within the field of view of the image capturing device. In operation 1122, the application can parse the physical scene rendered on the display into the discrete elements based on dimensions of items in the physical scene. In operation 1124, the application can extract and decode the identifying information associated with at least one of the one or more cases. In operation 1126, the application can transmit the identifying information of the at least one of the one or more cases to the computing system. In operation 1128, in response to receiving instructions from the computing system, the physical scene rendered on the display can be augmented to superimpose the virtual element depicting identifying mark on the at least one of the one or more cases.

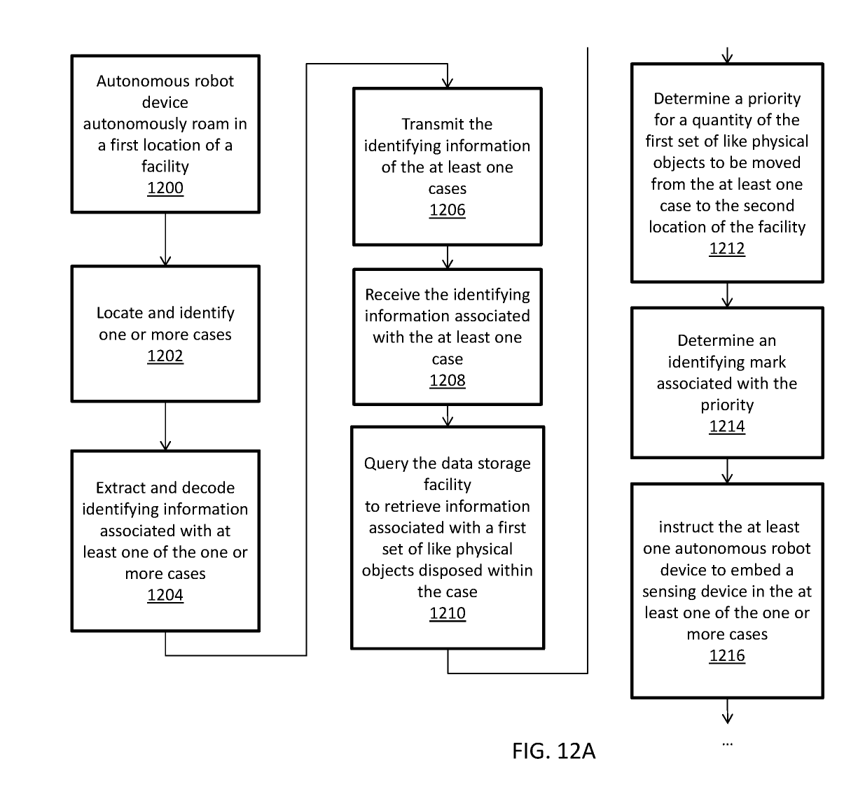

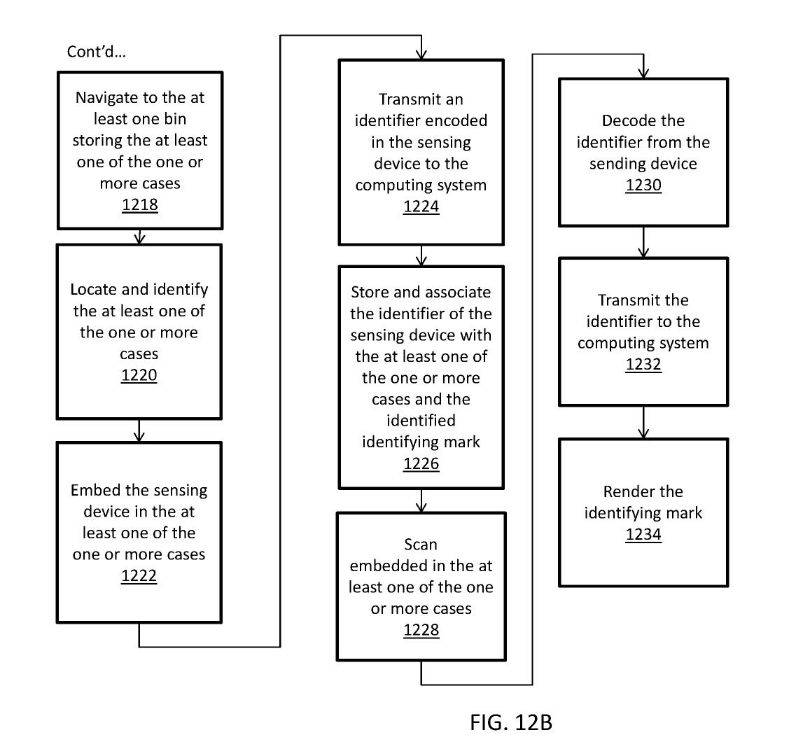

With reference to FIGS. 12A-12B a flowchart illustrating the process of the autonomous marking system according to exemplary embodiment is depicted. With reference to FIG. 12A, in operation 1200, an autonomous robot device (e.g. autonomous robot device 300 as shown in FIGS. 3 and 7) can autonomously roam in a first location of a facility. The autonomous robot device can be in selective communication with a computing system (e.g., a computing system 700 as shown in FIG. 7) via a communications network (e.g., network 715 as shown in FIG. 7). In operation 1202, the autonomous robot device can locate and identify one or more cases (e.g., cases 310, 310a-c, 762 as shown in FIGS. 3-4, 7) stored in at least one of a plurality of bins (e.g., bins 320a-c, 760 as shown in FIG. 3-4, 7) in the first location of the facility. Each case can contain a set of like physical objects (e.g. physical objects 104 as shown in FIG. 1). In operation 1204, the autonomous robot device can extract and decode, via the at least one autonomous robot device, identifying information (e.g., labels 312, 312a-c as shown in FIGS. 3-4) associated with at least one of the one or more cases using the image capturing device or the reader. In operation 1206, the autonomous robot device can transmit the identifying information of the at least one of the one or more cases to the computing system. In operation 1208, the computing system can receive the identifying information associated with the at least one of the one or more cases. In operation 1210, the computing system can query the data storage facility (e.g., the physical objects database 725, the bins database 735 and the cases database 740 as shown in FIG. 7) to retrieve information associated with a first set of like physical objects disposed within the case. In operation 1212, the computing system can determine a priority for a quantity of the first set of like physical objects to be moved from the at least one of the one or more cases to the second location of the facility. In operation 1214, the computing system can identify an identifying mark for the at least one of the one or more cases based on the priority. In operation 1216, the computing system can instruct the at least one autonomous robot device to embed a sensing device in the at least one of the one or more cases.

With reference to FIG. 12B, in operation 1218, the autonomous robot device can navigate to the at least one bin storing the at least one of the one or more cases. In operation 1220, the autonomous robot device can locate and identify the at least one of the one or more cases. In operation 1222, the autonomous robot device can embed the sensing device in the at least one of the one or more cases. In operation 1224, the autonomous robot device can transmit an identifier encoded in the sensing device to the computing system.

In operation 1226, the computing system can store and associate the identifier of the sensing device with the at least one of the one or more cases and the identified identifying mark. In operation 1228, a portable electronic device (e.g., portable electronic device 200 as shown in FIGS. 2, 5 and 7), in communication with the computing system and executing an application (e.g., augmentation application 745 as shown in FIG. 7), can scan the sensing device embedded in the at least one of the one or more cases using the reader of the portable electronic device. In operation 1230, the portable electronic device can execute the application to decode the identifier from the sending device. In operation 1232, the portable electronic device can execute the application to transmit the identifier to the computing system. In operation 1234, the portable electronic device can execute the application to render the identifying mark associated with the at least one of the one or more cases on the display, in response to receiving instructions.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An autonomous marking system, the system comprising:
a computing system in communication with a data storage facility;
a plurality of autonomous robot devices in selective communication with the computing system via a communications network, at least one of the plurality of autonomous robot devices including a controller, a drive motor, a dispensing device, a reader and an image capturing device,
the at least one of the autonomous robot devices configured to (i) autonomously roam in a first location of a facility, (ii) locate and identify one or more cases stored in at least one of a plurality of bins in the first location of the facility, wherein each case containing a set of like physical objects, (iii) extract and decode identifying information associated with at least one of the one or more cases, (iv) transmit the identifying information of the at least one of the one or more cases to the computing system,
wherein the computing system is programmed to receive the identifying information associated with the at least one of the one or more cases, query the data storage facility to retrieve information associated with a first set of like physical objects disposed within the case, instruct the at least one autonomous robot device to mark the at least one of the one or more cases with a identifying mark denoting the determined priority, and
wherein the at least one autonomous robot device is configured to navigate to the at least one bin storing the at least one of the one or more cases, locate and identify the at least one of the one or more cases, and mark the identifying mark on the at least one of the one or more cases using the dispensing device.

2. The system in claim 1, wherein in response to the computing system is programmed to determine a quantity of a second set of like physical objects disposed in a second location of the facility is below a specified amount, determine a priority for a quantity of the first set of like physical objects to be moved from the at least one of the one or more cases, in the first location of the facility, to the second location of the facility.

3. The system in claim 1, wherein in response to the computing system instructing the autonomous robot device to mark the at least one of the one or more cases with the identifying mark, the autonomous robot device is configured to:
determine the at least one of the one or more cases is not visible to the autonomous robot device;
marks an outside surface of the at least one bin with the identifying mark denoting the determined priority.

4. The system in claim 1, wherein the autonomous robot device extracts and decodes identifying information of the at least one of the one or more cases using the reader and the image capturing device.

5. The system in claim 1, wherein the identifying mark is one or more of: a color, a shape, a date, inscription, or figure.

6. The system in claim 1, wherein the autonomous robot device is an autonomous ground vehicle (AGV) or an unmanned aerial vehicle (UAV).

7. The system of claim 1, wherein the autonomous robot device includes an actuator coupled to the dispensing device.

8. The system of claim 7, wherein the dispensing device expels material in response to the actuator being actuated.

9. The system of claim 8, wherein the dispensing device is one or more of a paint gun, a writing instrument, a laser, and/or a sticker dispenser.

10. An automated marking method, the method comprising:
autonomously roaming, via at least one of a plurality of autonomous robot devices in selective communication with a computing system via a communications network, at least one of the plurality of autonomous robot devices including a controller, a drive motor, an dispensing device, a reader and an image capturing device, in a first location of a facility;
locating and identifying, via the at least one autonomous robot device, one or more cases stored in at least one of a plurality of bins in the first location of the facility, wherein each case containing a set of like physical objects;
extracting and decoding, via the at least one autonomous robot device, identifying information associated with at least one of the one or more cases;
transmitting, via the at least one autonomous robot device, the identifying information of the at least one of the one or more cases to the computing system;
receiving, via the computing system in communication with a data storage facility, the identifying information associated with the at least one of the one or more cases;
querying, via the computing system, the data storage facility to retrieve information associated with a first set of like physical objects disposed within the case;
instructing, via the computing system, the at least one autonomous robot device to mark the at least one of the one or more cases with a identifying mark denoting a priority;
navigating, via the at least one autonomous robot device, to the at least one bin storing the at least one of the one or more cases;
locating and identifying, via the at least one autonomous robot device, the at least one of the one or more cases; and
marking, via the at least one autonomous robot device, the identifying mark on the at least one of the one or more cases using the dispensing device.

11. The method in claim 10, further comprising:
determining, via the computing system, a quantity of a second set of like physical objects disposed in a second location of the facility is below a specified amount;
determining, via the computing system, the priority for a quantity of the first set of like physical objects to be moved from the at least one of the one or more cases to the second location of the facility;

12. The method in claim 10, in response to the computing system instructing the autonomous robot device to mark the at least one of the one or more cases with the identifying mark, further comprising:
determining, via the at least one autonomous robot device, the at least one of the one or more cases is not visible;
marking, via the at least one autonomous robot device, an outside surface of the at least one bin with the identifying mark denoting the determined priority.

13. The method in claim 10, wherein the autonomous robot device extracts and decodes identifying information of the at least one of the one or more cases using the reader and the image capturing device.

14. The method in claim 10, wherein the identifying mark is one or more of: a color, a shape, a date, inscription, or figure.

15. The method in claim 10, wherein the autonomous robot device is an autonomous ground vehicle (AGV) or an unmanned aerial vehicle (UAV).

16. The method of claim 10, wherein the autonomous robot device includes an actuator coupled to the dispensing device.

17. The method of claim 16, further comprising expelling, via the dispensing device, material in response to the actuator being actuated.

18. The method of claim 17, wherein the dispensing device is one or more of a paint gun, a writing instrument, a laser, and/or a sticker dispenser.

19. An autonomous marking system, the system comprising:
a computing system in communication with a data storage facility;
a plurality of autonomous robot devices in selective communication with the computing system via a communications network, at least one of the plurality of autonomous robot devices including a controller, a drive motor, an dispensing device, a reader and an image capturing device,
the at least one of the autonomous robot devices configured to (i) autonomously roam in a first location of a facility, (ii) locate and identify one or more cases stored in at least one of a plurality of bins in the first location of the facility, wherein each case containing a set of like physical objects, (iii) extract and decode identifying information associated with at least one of the one or more cases, (iv) transmit the identifying information of the at least one of the one or more cases to the computing system,
wherein the computing system is programmed to receive the identifying information associated with the at least one of the one or more cases, query the data storage facility to retrieve information associated with a first set of like physical objects disposed within the at least one of the one or more cases, identify an identifying mark associated with the priority, generate a virtual element depicting the identifying mark, associate the virtual element with the at least one of one or more cases in the data storage facility, and
a portable electronic device including an image capturing device, a display, including an application, and in communication with the computing system, the application when executed is configured to (i) control the operation of the image capturing device to contemporaneously and continuously image an area within a field of view of the image capturing device, (ii) render, on the display, a physical scene including the at least one of the one or more cases and the identifying information associated with the at least one of the one or more cases disposed in the field of view of the image capturing device, (iii) parse the physical scene rendered on the display into the discrete elements based on dimensions of items in the physical scene, (iv) extract and decode the identifying information associated with at least one of the one or more cases, (v) transmit the identifying information of the at least one of the one or more cases to the computing system, and (vi) in response to receiving instructions from the computing system, augment the physical scene rendered on the display to superimpose the virtual element depicting identifying mark on the at least one of the one or more cases.

20. An autonomous marking system, the system comprising:
a computing system in communication with a data storage facility;
a plurality of autonomous robot devices in selective communication with the computing system via a communications network, at least one of the plurality of autonomous robot devices including a controller, a drive motor, an dispensing device, a reader and an image capturing device,
the at least one of the autonomous robot devices configured to (i) autonomously roam in a first location of a facility, (ii) locate and identify one or more cases stored in at least one of a plurality of bins in the first location of the facility, wherein each case containing a set of like physical objects, (iii) extract and decode identifying information associated with at least one of the one or more cases, (iv) transmit the identifying information of the at least one of the one or more cases to the computing system,
wherein the computing system is programmed to receive the identifying information associated with the at least one of the one or more cases, query the data storage facility to retrieve information associated with a first set of like physical objects disposed within the case, identify an identifying mark for the at least one of the one or more cases based on the retrieved information, instruct the at least one autonomous robot device to embed a sensing device in the at least one of the one or more cases, and
wherein the at least one autonomous robot device is configured to navigate to the at least one bin storing the at least one of the one or more cases, locate and identify the at least one of the one or more cases, embed the sensing device in the at least one of the one or more cases, transmit an identifier encoded in the sensing device to the computing system.

21. The system of claim 20, wherein the computing system is configured to store and associate the identifier of the sensing device with the at least one of the one or more cases and the identified identifying mark.

22. The system of claim 21, further comprising a portable electronic device including an application, a reader, a display and in communication with the computing system, the application when executed configured to:
scan, using the reader, the sensing device embedded in the at least one of the one or more cases;
decode the identifier from the sending device;
transmit the identifier to the computing system;
render the identifying mark associated with the at least one of the one or more cases on the display, in response to receiving instructions.
